(19) United States
(12) Patent Application Publication
(10) Pub. No.: US 2015/0064004 A1
(43) Pub. Date: Mar. 5, 2015

(54) PERSONAL PROPULSION APPARATUS AND METHOD

(71) Applicant: Dreamscience Propulsion Limited, Staffordshire (GB)

(72) Inventor: Adam Edward Alexander Contoret, Stoke-on-Trent (GB)

(73) Assignee: Dreamscience Propulsion Limited, Staffordshire (GB)

(21) Appl. No.: 14/367,691

(22) PCT Filed: Dec. 18, 2012
(86) PCT No.: PCT/GB2012/053172

§ 371 Date: Jun. 20, 2014

(30) Foreign Application Priority Data
Dec. 23, 2011 (GB) 1122273.4

(51) Int. Cl. B64C 39/02

(52) U.S. Cl. CPC B64C 39/026
USPC 416/1; 416/63

(57) ABSTRACT

A personal propulsion apparatus and method are disclosed. The apparatus includes first and second air-moving thrusters arranged at opposed ends a rigid member and drive means operable to cause the thrusters to move

The present invention relates to a person propulsion apparatus and method. In particular, but not exclusively, the present invention relates to an apparatus and method for use principally in sporting or physical activities, in particular so-called “extreme sports” including skateboarding, snowboarding, skiing, surfing, power kiting and the like. The present invention provides an improved means of propulsion for use by an individual when engaging in such or similar activities.

### BACKGROUND

Personal propulsion means for sporting and physical activities per se are known. Examples include:

US 2007/0010143 and U.S. Pat. No. 7,690,958 (Burgess) which teaches a large single propeller attached to a harness and mounted on a user's back;

U.S. Pat. No. 7,179,141 (McMullen) which teaches a harness by which a user mounts an internal combustion engine on his back. The internal combustion engine has a belt-drive to an axle of a single propeller, which in turn is intended to impart motion to a user, e.g. when skiing;

U.S. Pat. No. 5,222,569 (Martel) teaches a motor and propeller for mounting to a user's rear pelvic area for providing forward thrust, such as when skiing;

US 2006/0196991 (Martin) teaches a personal flight device which includes an engine and at least a pair of tiltable fans driven by the motor. The fans and motor are mounted on a housing which is secured to a pilot.

All of the above devices lack a high degree of flexibility and controllability for use in physical and sporting activities.

The present invention seeks to obviate, or at least alleviate, disadvantages associated with prior art apparatus such as those identified above.

### STATEMENTS OF INVENTION

According to a first aspect of the present invention there is provided personal propulsion apparatus comprising first and second air-moving thrusters arranged at opposed ends of a rigid member and drive means operable to cause the thrusters to move air.

Aptly, each thruster comprises a housing mounted to a respective end of said rigid member, and an air moving device mounted within the housing.

Aptly, the drive means comprises an electric motor. In preferred embodiments each thruster has an associated electric motor.

In further preferred embodiments the personal propulsion apparatus further comprises an electric power source for the electric motor.

In preferred embodiments, in each housing is mounted the air moving device, and in or on each housing is mounted an electric motor operable to rotate the air moving device.

Aptly, the personal propulsion apparatus further comprises an electric power source for the electric motor mounted in or on the respective housings.

Aptly, the personal propulsion apparatus further comprises a belt or harness configured for mounting to a user's body and attachment means for attaching the rigid member and/or the respective thrusters to the belt or harness.

Aptly, the attachment means is a flexible attachment.

In some preferred variations the attachments means comprises a cord, cable, strap, wire, line or the like.

In further preferred embodiments the respective thrusters are spaced apart by a length not less than the span of a user's shoulders, and preferably by a length of about 60 to 120 cm.

Aptly, the personal propulsion apparatus further comprises gripping means or a gripping surface arranged on the rigid member and configured to be held by a user's hands.

According to a second aspect of the present invention, there is provided a kit of parts comprising a personal propulsion device as defined in the first aspect of the invention and at least one member selected from the group comprising skis, a bicycle, tricycle or quadricycle, a skateboard, roller-skates, a surfboard, a snowboard, a land board, a water craft or a land yacht chassis.

According to a third aspect of the invention there is provided a method of propelling a user over land or water, the method comprising providing a personal propulsion apparatus as defined in the first aspect of the invention, providing carriage means selected from skis, ice skates, a bicycle, tricycle or quadricycle, a skateboard, roller-skates, roller-blades, a land board, a land yacht chassis, a snowboard, a water craft or the like,
the user grasping and holding the rigid member in his hands,
causing the thrusters to move air, thereby to propel the user, and
adjusting the orientation of the personal propulsion device by moving the rigid member, thereby to adjust the direction of thrust, relative to the user, imparted by the thrusters.

### BRIEF DESCRIPTION OF THE DRAWINGS

For a better understanding of the invention and to show how the same may be carried into effect, reference will be made, by way of example only, to the following drawings, in which:

FIG. 1 is a sketch showing schematically a front view of an apparatus according to the invention;

FIG. 2 is a sketch showing schematically a top plan view of an apparatus according to the invention;

FIG. 3 is an image showing a typical user holding an apparatus of the invention while standing on a land board;

FIGS. 4a to 4d are images of a typical user holding an apparatus of the invention in different orientations and positions.

### DETAILED DESCRIPTION

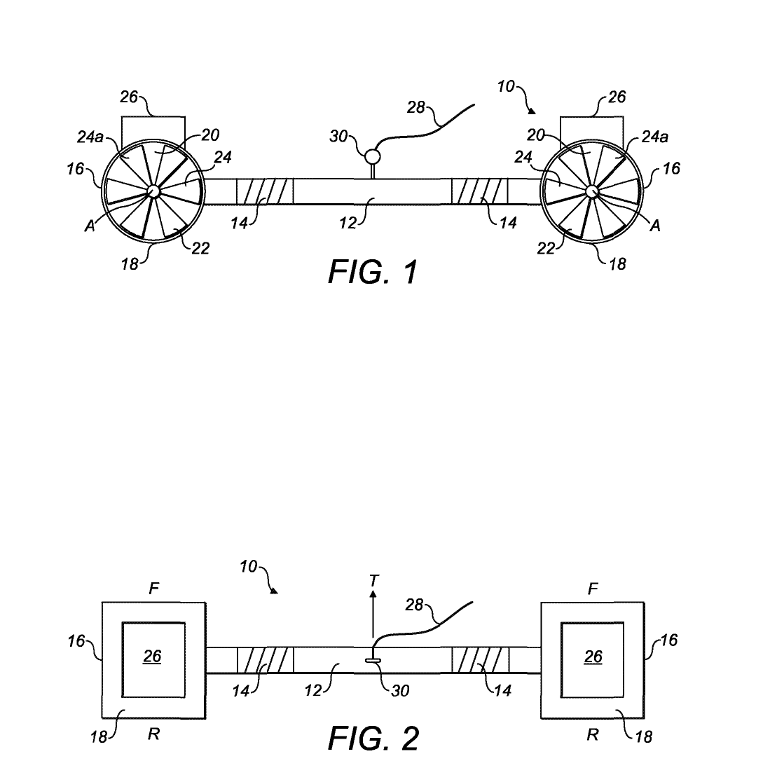

Referring now to the drawings, the apparatus 10 of the invention comprises a rigid member 12 which is typically a bar or tube made from a lightweight material. Suitably, the rigid member 12 is made from a lightweight metal or a suitably strong plastic or plastics composite material. In some preferred forms, the rigid member 12 is straight (i.e. rectilinear). However, in particular embodiments, the rigid member 12 may be curved, or include curves, for example to provide gripping portions which facilitate the holding of the rigid member 12 in a user's hands. Gripping portions or regions are schematically illustrated at 14 in FIGS. 1 and 2. Such gripping portions 14 may, for example have a surface comprising a high friction material, for example a rubbery material, on which a user can maintain a strong and comfortable grip.

At respective opposed ends of the rigid member 12 is mounted a thruster 16. That is, each end of the rigid member 12 carries a thruster 16. Any suitable means known in the art may be used to attach the thrusters 16 to the respective ends of the rigid member 12, for example by means of mechanical fastening means, for example clips or bolts, or by suitably strong adhesive, or by welding.

Each thruster 16 comprises a housing 18 which is attached to the respective end of the rigid member 12. The housing 18 defines a channel or passage 20 that defines an air flow pathway through the housing.

Associated with each passage 20 is an air moving means 22. Preferably the air moving means 22 comprises a fan or propeller 24 with a plurality of air-moving blades 24a. Preferably the air moving means is mounted with the passage 20. Air moving means 22 is configured to cause, in operation, a flow of air through the passage 20 from the front side F to the rear side R of the apparatus. The movement of air through the passage 20 by the air moving means 22 is sufficient to provide a forward thrust (that is, generally in the direction of arrow T) to the apparatus 10.

The housing 18 also provides protection against a rotor failure by the air moving means 22.

Air moving means 22 will, in preferred embodiments, cause movement of air through passage 22 by rotation of a fan or propeller about an axis A, extending perpendicular to the plane of the page in FIG. 1, that is, from the front to the back of the housing. The axis A will normally be arranged substantially centrally with respect to the passage 20.

A drive means or arrangement is provided to cause rotation of the fan or propeller about axis A. Preferred drive means is an electric motor. A single electric motor may be provided to drive the air moving means 22 of both thrusters 16, for example by way of drive belts or drive shaft. In this case, the motor may conveniently be mounted on the rigid member 12, approximately equidistantly from the respective thrusters 16. In preferred arrangements, however, each air moving means 22 has an associated electric motor which is preferably arranged co-axially with the air moving means (that is, co-axially with the fan or propeller 24, in preferred embodiments). In some preferred embodiments, the electric motor is coupled directly to the fan or propeller 24 without any intervening gearing or linkage.

The rotation of the fan or propeller about the axis A may be in the region of 10,000 to 100,000 rpm and more aptly between 25,000 and 45,000 rpm and even more aptly around 35,000 rpm. The thrust values may be around 30 to 50 pound of thrust (15 to 25 kg) per thruster 16. The thrust should be sufficient to propel the user, with net thrust possibly lower than the combined weight of the user and apparatus.

The drive means requires a power source in order operably to cause movement of the air moving means 22. Where the drive means is an electric motor, the power source is conveniently a battery, or a battery pack. Other known portable sources of electric power are useable in principle, provided always that such sources can conveniently be carried by a user while engaging in physical activity (e.g. sport) using the apparatus of the invention. A battery pack is illustrated schematically at 26 in FIGS. 1 and 2. As illustrated, the battery pack 26 is mounted on the outside of housing 18, but other locations may be possible, for example within the housing 18 (if the housing 18 is appropriately shaped) or within a hollow interior part of rigid member 12. The location of battery packs for the respective thrusters 16 (specifically for the drive means of the air moving means 22) is selected to ensure that the weight of the battery packs is evenly distributed with respect to the apparatus as a whole. It would be undesirable for one thruster 16 to appear to a user to be heavier than the other thruster 16.

In alternative arrangements, one or more battery packs 26 may be carried about the user's person, for example by means of a supporting harness, the battery pack 26 being connected to the electric motors by suitable electrical connectors, notably wires.

Typically, each of the thrusters may require in the region of 5 to 25 KW of energy, which may be delivered by a lithium polymer (LiPo) battery pack via an electronic speed controller to brushless motors with high magnetic fields. A fan with diameter of around 15 cm diameter turning at around 35,000 rpm using brushless motor and 14 cell LiPo battery of 5 AmpHour rating will produce about 12 kg of thrust. Current draw would be 150 Amps at 54 Volts (corresponding to about 8000 Watt power consumption).

The wind speed leaving the thruster 16 may be around 100 ms⁻¹ or more, which is higher than conventional propellers (that turn at a few thousand rpm). As such, the torque on the thruster shaft is very low compared to a conventional propeller, resulting in a higher degree of manoeuvrability of the apparatus and more predictable control, avoiding torque steer. Also, the high wind velocity output of each thruster ensures that thrust is not significantly reduced by motion of the apparatus as the speed differential is not as significant. As such, even under extreme speeds including freefall the apparatus remains manoeuvrable.

In some embodiments, fastening means 28 may be provided for attaching the apparatus 10 to a user's body, for example to a harness or belt. For example, the fastening means may attach the apparatus 10 to the user's body such that the apparatus is held forward of the user's body. In this case the apparatus would act to pull the user along rather than push the user. The fastening means may typically be in the form of a line, cord, wire, cable, strap or belt. In some configurations the fastening means 28 may be sufficiently robust to assist in conveying thrust from the apparatus 10 to a user's body. This may have the advantage of reducing the strain on a user's arms as he holds the apparatus 10 in use, so allowing greater precision by the user in setting the orientation, attitude or alignment of the apparatus 10. In other embodiments, the fastening means 28 is intended only to prevent separation of the apparatus 10 from the user in the event that the user lets go of the rigid member 12, for example as a result of an inadvertent trip or fall. In some embodiments, the fastening means maybe provided with user-operated quick release means, shown schematically at 30 in FIGS. 1 and 2. Such means are, per se, well known in the art. In some embodiments, the fastening means may attach the apparatus to the user such that the thrust force acts through the user's centre of mass. This may be useful when it is preferred the apparatus propels the user from their centre of mass, rather than producing an adverse moment that may affect the user's balance or direction.

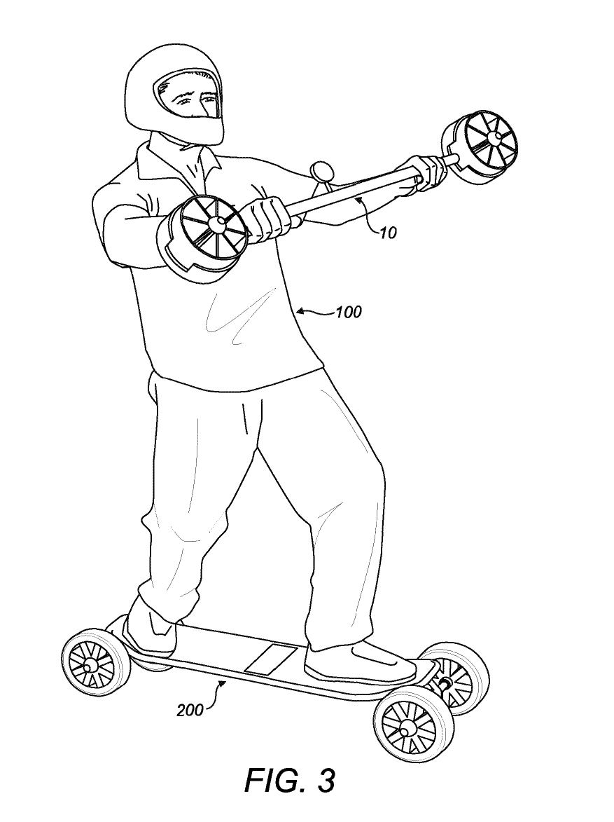

Referring now in particular to FIG. 3, a user 100 is shown grasping an apparatus 10 of the invention. The user 100 is standing on a land board 200. A land board 200 is broadly similar to a conventional skateboard but is generally larger and has four wheels mounted externally of the board perimeter (in contrast to a skateboard where the wheels are typically arranged underneath the board). Land boards are known for use in the sport of kite land boarding where the user is pulled along overland (beach, hard surface, grass etc) by a kite. The land board 200 is just one example of a suitable vehicle or conveyance for use with the apparatus of the invention, other examples including skateboards, bicycles, tricycles, quadricycles, roller-blades, roller-skates, skis and snowboards. The apparatus 10 may be used in water sports in conjunction with water craft (small boats, dinghies, canoes and kayaks), surfboards and the like. In other possibilities, the apparatus 10 can be used in conjunction with the chassis of a land yacht (that is, a land yacht without its mast and sail) or similarly constructed vehicles.

As can be seen from FIG. 3, in use, the user 100 grasps the apparatus 10 so that a firm hold is obtained on the rigid member 12. The user 100 holds the apparatus 10 generally forwardly of his body with the thrusters 16 in operation. A “jet” of air is provided from each thruster 16, in a rearward direction, so urging the apparatus 10 to move forwardly. As the user 100 is mounted on land board 200, the thrust imparted by the thrusters 16 causes the land board 200 to move forward, carrying the user in a forward direction.

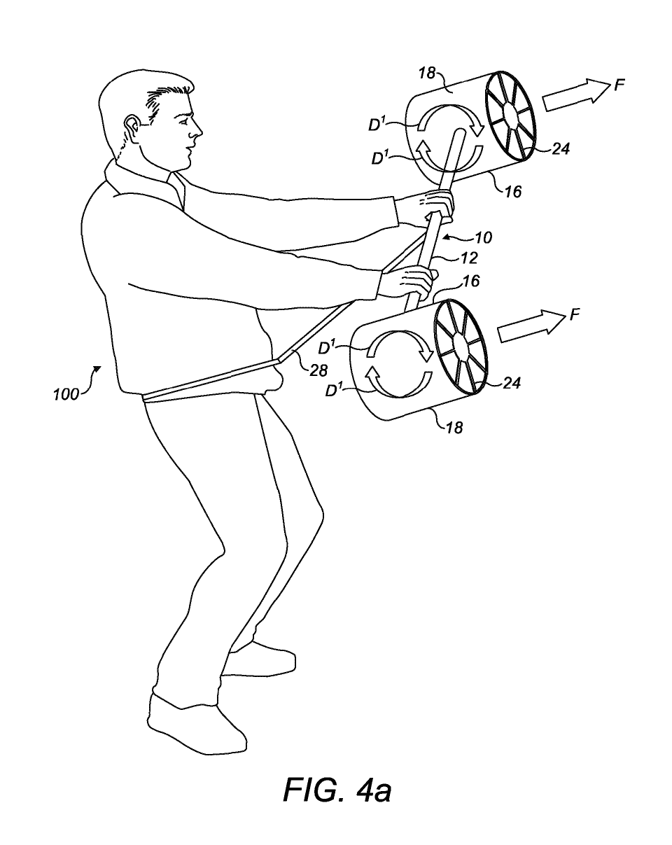

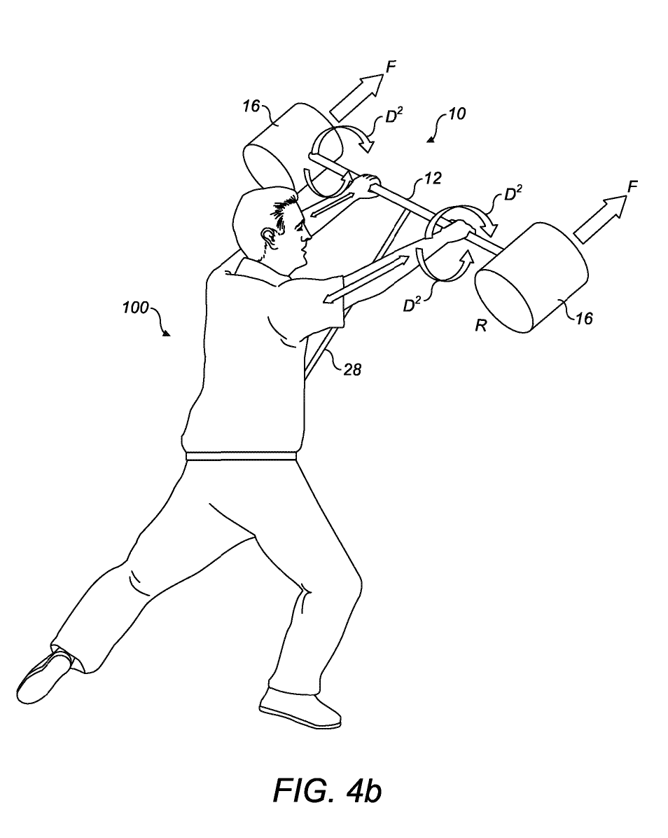

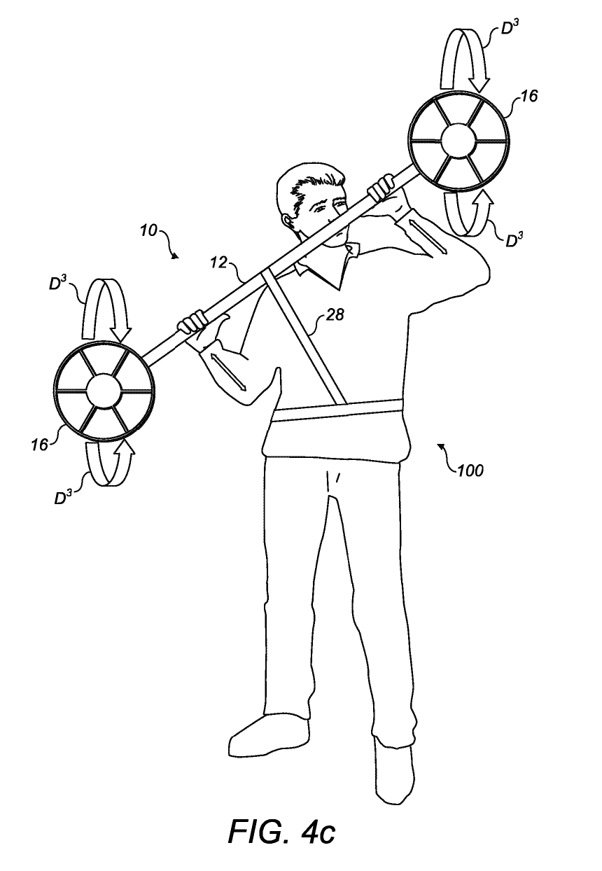

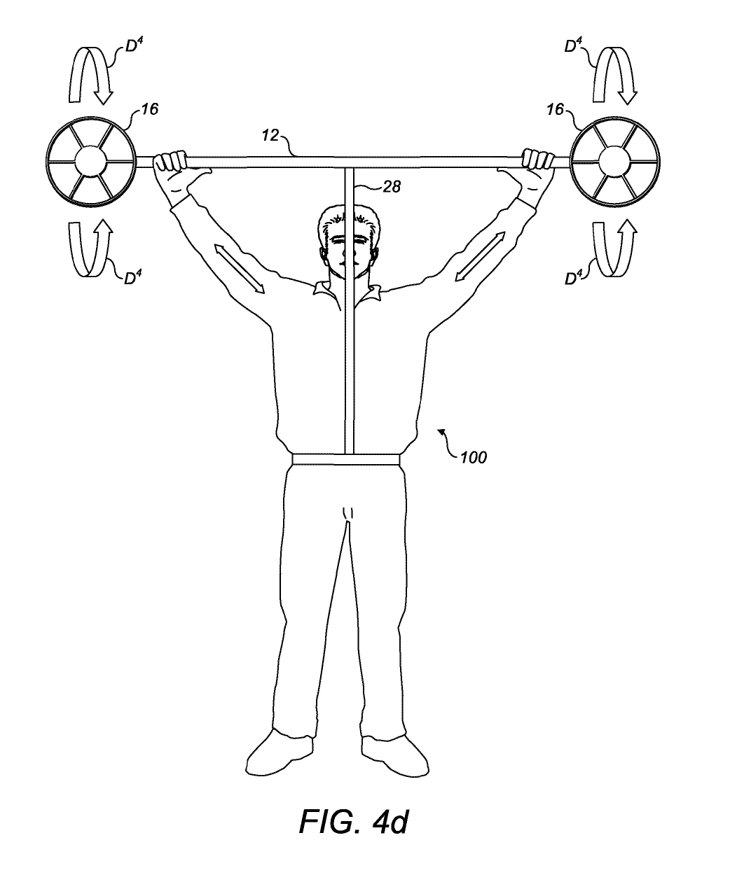

FIGS. 4a to 4d illustrate some of the various different attitudes and orientations which a user 100 may cause the apparatus 10 to adopt, in order to control his motion. As will be clearly apparent, the user 100 can position the apparatus 20 by movement of his wrists, elbows and shoulders so that an almost infinite number of positions of the apparatus 10 can be adopted. Arrows D¹ to D⁴ illustrate possible rotations of the apparatus 10 (by movement of the user's wrists) to vary the orientation of the apparatus 10. A user 100 soon becomes adept at setting the position, orientation and/or attitude of the apparatus 10 to match his desired speed and direction of motion. In a particular example, deceleration can be achieved by rotation of the apparatus so that the propulsion force is directed rearwardly.

In further embodiments, a user operable control device may be provided by means of which the user 100 can control the operation of the thrusters 16. In particular, the user may control the amount of thrust provided by controlling the speed of movement of the air moving means 22. In further embodiments, the control device is operable to control the respective thrusters 16 independently, for example to compensate for environmental conditions (wind, terrain) or for changes of direction.

A user operable control device may comprise a mouth-operated controller to stop, start, increase speed, decrease speed, etc. of the thrusters. This would enable the user to keep both hands free to grip the rigid member.

It will be appreciated that in general the apparatus of the invention may be used to assist a user in sporting activities to increase their velocity and momentum compared to the usual velocities and momentums achieved without such apparatus.

It will be appreciated that with the present invention, superior control and handling of the apparatus can be achieved compared to prior known devices. Furthermore, although the apparatus of the present invention may require a higher fan speed than some known devices, the apparatus will be lighter and have a profile with a smaller surface area than known devices. Thus, less drag will be encountered in use.

In addition, since the apparatus allows for more acute handling, with the direction of thrust being completely controllable, this can have further benefits in terms of safety as well as user enjoyment. For example, avoidance of obstacles or hazards is more easily achievable.

Furthermore, by swivelling the rigid member by 180°, for example, it is possible to reverse the direction of thrust and enable a controlled stop. In use in an airborne activity, it may be possible to use the apparatus to slow or arrest the decent of the user. Typically known parachutes cannot operate in the height range of less than 100 m.

It will also be appreciated that since the source of thrust is forward of the centre of mass of the moving body, this arrangement will be inherently more stable than having a thrust source behind the body. For example, in a crash situation, the human body is often thrown forward with a forward momentum. With known apparatus located behind the body, the apparatus could continue to push the body forward. With the present invention, the apparatus will thrust forward of the centre of mass and likely detach from the body. The invention could include a safety measure to ensure that the thrusters are automatically stopped upon detachment from a user.

With the present invention, the attachment of the apparatus to the front area of a user's body enables standard sporting equipment, for example a paragliding harness or power kite harness, to be fitted over the apparatus without special adaptation to either part. Also, the apparatus's position of use with respect to the body lies out of the field of use of most sporting equipment, and thus does not interfere with the wearing or the functioning of the sporting equipment.

Furthermore, as a safety aspect, it will be appreciated that providing a connecting part between the thrusters and the body that is also forward of the user's body will allow the user to more easily reach for a quick release button for example in an emergency situation, which would be more difficult to do if the thrusters were mounted on the user's back as per prior art devices.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A personal propulsion apparatus comprising first and second air-moving thrusters arranged at opposed ends of a rigid member and drive means operable to cause the thrusters to move air.

2. A personal propulsion apparatus as claimed in claim 1 wherein each thruster comprises a housing mounted to a respective end of said rigid member, and an air moving device mounted within the housing.

3. A personal propulsion apparatus as claimed in claim 1 wherein the drive means comprises an electric motor.

4. A personal propulsion apparatus as claimed in claim 3 wherein each thruster has an associated electric motor.

5. A personal propulsion apparatus as claimed in claim 3 further comprising an electric power source for the electric motor.

6. A personal propulsion apparatus as claimed in claim 2 wherein in each housing is mounted the air moving device and in or on each housing is mounted an electric motor operable to rotate the air moving device.

7. A personal propulsion apparatus as claimed in claim 6 further comprising an electric power source for the electric motor mounted in or on the respective housings.

8. A personal propulsion apparatus as claimed in claim 1 further comprising a harness or belt configured for mounting on a user's body and attachment means for attaching the rigid member and/or the respective thrusters to the harness or belt.

9. A personal propulsion apparatus as claimed in claim 8 wherein the attachment means is a flexible attachment means.

10. A personal propulsion apparatus as claimed in claim 9 wherein the attachment means comprises a cord, cable, strap, wire, line, belt or the like.

11. A personal propulsion apparatus as claimed in claim 1 wherein the respective thrusters are spaced apart by a length not less than the span of a user's shoulders.

12. A personal propulsion apparatus as claimed in claim 1 further comprising gripping means or a gripping surface arranged on the rigid member and configured to be held by a user's hands.

13. A personal propulsion apparatus as claimed in claim 1 wherein the personal propulsion apparatus is configured to be held forward of a user's body.

14. A kit of parts comprising a personal propulsion apparatus as claimed in claim 1 and at least one member selected from the group comprising skis, ice skates, a bicycle, tricycle or quadricycle, a skateboard, roller-skates, roller-blades, a surfboard, a snowboard, a land board, a watercraft or a land yacht chassis.

15. A method of propelling a user over land or water, the method comprising providing a personal propulsion apparatus as claimed in any of claim 1, providing carriage means selected from skis, ice skates, a bicycle, tricycle or quadricycle, a skateboard, roller-skates, roller blades, a land board, a land yacht chassis, a snowboard, a surfboard or a watercraft or the like,
the user grasping and holding the rigid member in his hands,
causing the thrusters to move air, thereby to propel the user, and
adjusting the orientation of the personal propulsion device by moving the rigid member, thereby to adjust the direct in the thrust, relative to the user, imparted by the thrusters.

16.-17. (canceled)

18. The personal propulsion apparatus of claim 11, wherein the length is about 60 cm to about 120 cm.
